(19) United States
(12) Patent Application Publication
(10) Pub. No.: US 2025/0377939 A1
(43) Pub. Date: Dec. 11, 2025

(54) HARDWARE ACCELERATOR WITH SCALE FACTOR APPLIED AT TENSOR PROCESSOR

(71) Applicant: Microsoft Technology Licensing, LLC, Redmond, WA (US)

(72) Inventors: Nitin Naresh GAREGRAT, San Jose, CA (US); Thomas Craig SAVELL, Emeryville, CA (US); Kyung-Nam HAN, Oviedo, FL (US)

(73) Assignee: Microsoft Technology Licensing, LLC, Redmond, WA (US)

(21) Appl. No.: 18/739,156

(22) Filed: Jun. 10, 2024

(51) Int. Cl. G06F 9/50; G06F 7/50; G06F 7/523

(52) U.S. Cl. CPC G06F 9/5027; G06F 7/50; G06F 7/523

(57) ABSTRACT

A hardware accelerator including input memory that receives first and second input matrices. The hardware accelerator further includes processing circuitry including one or more tiles that each include a respective tensor processor configured to receive a first and second input block of the first and second input matrices. Each tile receives a first block scale factor associated with rows of the first input block and a second block scale factor associated with columns of the second input block. Each tile multiplies the first input block by the second input block, applies the first block scale factor to rows of the result block, and applies the second block scale factor to columns of the result block to obtain a scaled result block. The processing circuitry further includes an accumulator that accumulates scaled result blocks to obtain a scaled result matrix, and output memory that receives and output the scaled result matrix.

### BACKGROUND

Hardware accelerators specialized for matrix operations are used in many computing processes. For example, such hardware accelerators are frequently used to perform training of machine learning models and inferencing by trained machine learning models. These hardware accelerators may perform operations such as matrix multiplication or elementwise addition more efficiently than other types of processing devices, thereby achieving speedups in machine learning model training and inferencing.

### SUMMARY

According to one aspect of the present disclosure, a hardware accelerator is provided, including input memory configured to receive a first input matrix and a second input matrix. The hardware accelerator further includes processing circuitry including one or more tiles, each tile of the one or more tiles including a respective tensor processor configured to receive a first input block of the first input matrix and a second input block of the second input matrix. Each tile is further configured to receive a first block scale factor that is associated with rows of the first input block and specifies a first predefined scale range. Each tile is further configured to receive a second block scale factor that is associated with columns of the second input block and specifies a second predefined scale range. Each tile is further configured to multiply the first input block by the second input block to obtain a result block. Each tile is further configured to apply the first block scale factor to rows of the result block and apply the second block scale factor to columns of the result block to thereby obtain a scaled result block. The scaled result block includes a plurality of scaled result block elements that are scaled to within a third scale range. The processing circuitry further includes an accumulator configured to accumulate a plurality of the scaled result blocks to obtain a scaled result matrix. The processing circuitry further includes output memory configured to receive and output the scaled result matrix.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 schematically shows an example computing system that includes a hardware accelerator, according to one example embodiment.

FIG. 2 schematically shows the hardware accelerator in additional detail, according to the example of FIG. 1.

FIG. 3 schematically shows the components included in a tile of the hardware accelerator, according to the example of FIG. 1.

FIG. 4A schematically shows the tile when matrix multiplication is performed and first and second block scale factors are applied at a tensor processor, according to the example of FIG. 3.

FIG. 4B schematically shows a front end of the tensor processor in additional detail when a scaled dot product is computed, according to the example of FIG. 4A.

FIG. 5 schematically shows a dot product array included in a front end of the tensor processor, according to the example of FIG. 4.

FIG. 6A schematically shows an example of first and second block-level scale factors, according to the example of FIG. 2.

FIG. 6B schematically shows an example of first and second tensor-level scale factors, according to the example of FIG. 2.

FIG. 7A shows a flowchart of a method for use with a hardware accelerator to perform a scaled matrix multiply operation, according to the example of FIG. 1.

FIGS. 7B-7C show additional steps of the method of FIG. 7A that may be performed at the tensor processor in some examples.

FIG. 8 shows a schematic view of an example computing environment in which the computing system of FIG. 1 may be instantiated.

### DETAILED DESCRIPTION

In machine learning models, model parameters for different layers of a neural network are typically stored as tensors of floating-point numbers. For example, the parameters may be expressed as eight-bit floating point (FP8), six-bit floating point (FP6), or four-bit floating point (FP4) numbers. The tensors are stored in memory and may be transmitted to hardware accelerators when operations on the tensors are performed.

During or after machine learning model training, the data formats of the parameters are sometimes changed to reduce the number of bits used to store each parameter. For example, parameters expressed as 32-bit floating-point (FP32), 16-bit floating-point (FP16), or Bfloat16 may be compressed down to FP8, FP6, or FP4 numbers. Compressing the parameters may allow training and inferencing to be performed at the machine learning model more quickly.

In examples in which such compression is performed, a scale factor may be used to maintain the numerical accuracy of the machine learning model. This scale factor rescales the range of values expressible by the compressed parameters. Accordingly, the numerical accuracy of the machine learning model may be maintained by mapping the range of a wider numeric format onto the compressed floating-point format.

In existing approaches to implementing a parameter scale factor in machine learning applications, the scale factor is applied to a tensor at a single-instruction-multiple-data (SIMD) or single-instruction-multiple-thread (SIMT) engine after performing matrix multiplication. The SIMD or SIMT engine may be included in a tile vector processor (TVP) included in the hardware accelerator. Accordingly, the scaling and the matrix multiplication are performed at separate hardware devices. This SIMD or SIMT tensor scaling is frequently inefficient and may act as a bottleneck in the process of performing a matrix operation. In order to address this inefficiency in existing parameter scaling approaches, a hardware accelerator is provided herein, as discussed in further detail below. This hardware accelerator is configured to perform both matrix multiplication and parameter scaling at a tensor unit, thereby increasing tensor processing efficiency by not requiring the use of a separate SIMD or SIMT engine. By performing multiplication and scaling at the tensor unit, oversubscription of a tile vector processor (TVP) is reduced, which increases the speed of performing the matrix multiplication.

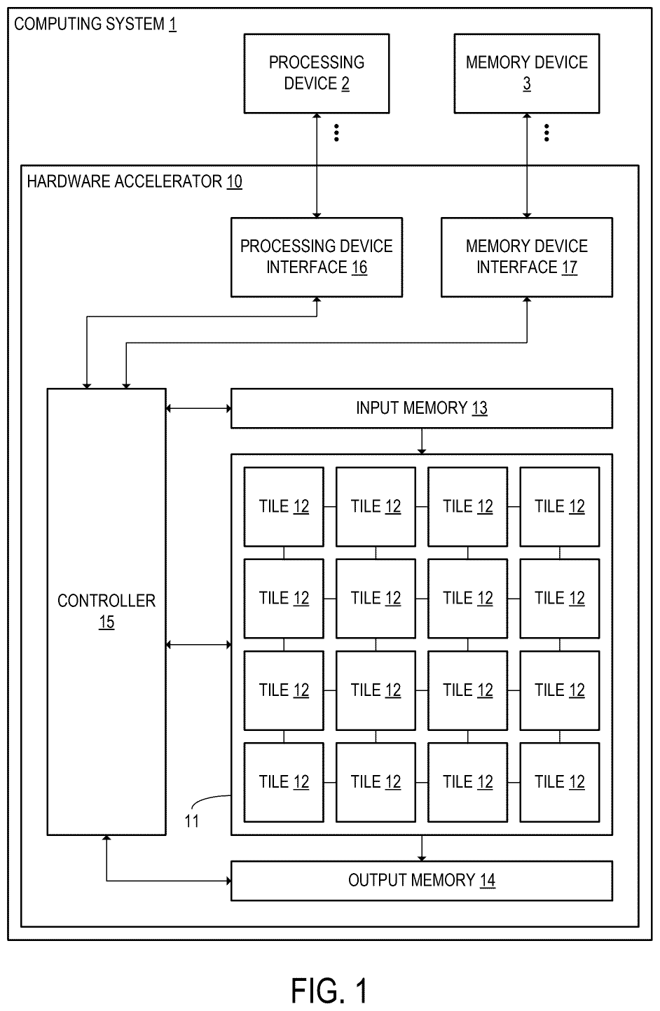

FIG. 1 schematically shows an example computing system 1 that includes a hardware accelerator 10. The hardware accelerator 10 may be included among a plurality of processing devices 2 of the computing system. The plurality of processing devices 2 may further include one or more central processing units (CPUs), application-specific integrated circuits (ASICs), field-programmable gate arrays (FPGAs), other hardware accelerators, and/or other types of processing devices. The computing system 1 further includes one or more memory devices 3, which may include one or more volatile memory devices and/or non-volatile storage devices. The computing system 1 may be implemented in a single physical computing device or in a plurality of networked physical computing devices, such as a plurality of server computing devices located in a data center.

The hardware accelerator 10, as shown in the example of FIG. 1, includes processing circuitry 11 at which matrix operations are performed. The processing circuitry 11 in the example of FIG. 1 is arranged in a plurality of tiles 12 that are configured to process respective blocks of matrices, as discussed in further detail below. The plurality of tiles 12 are arranged in a rectangular grid in the example of FIG. 1. In other examples, the processing circuitry 11 may be structured as a single tile 12. The hardware accelerator 10 further includes input memory 13 configured to store inputs to the hardware accelerator 10 and output memory 14 configured to store outputs of the hardware accelerator 10.

In the example of FIG. 1, the hardware accelerator 10 further includes a controller 15 that is configured to schedule and control the flow of data between different regions of the hardware accelerator 10. The example hardware accelerator 10 further includes a processing device interface 16 via which the hardware accelerator 10 is configured to communicate with the one or more additional processing devices 2 of the computing system 1. In addition, the hardware accelerator 10 further includes a memory device interface 17 via which the hardware accelerator 10 is configured to communicate with the one or more memory devices 3. For example, the memory device interface 17 may be configured to perform direct memory access (DMA).

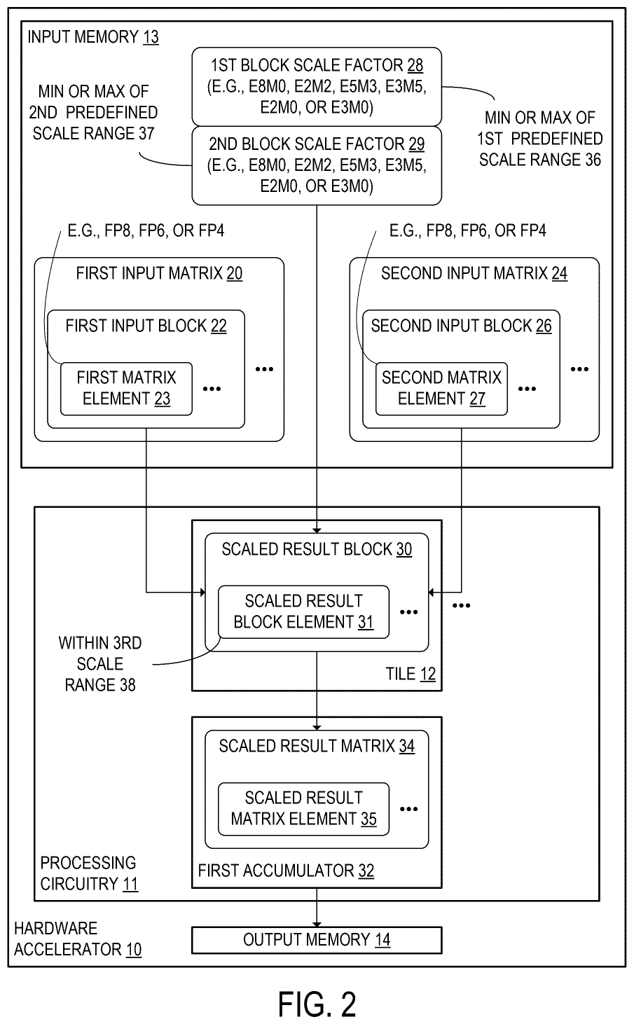

FIG. 2 schematically shows the hardware accelerator 10 in additional detail, according to the example of FIG. 1. As shown in FIG. 2, the input memory 13 of the hardware accelerator 10 is configured to receive a first input matrix 20 including a plurality of first matrix elements 23. The first matrix elements 23 are organized into a plurality of first input blocks 22, which are sub-matrices of the first input matrix 20. For example, the first input blocks 22 may be 16×16 blocks, 32×32 blocks, or 64×64 blocks. In other examples, the first input blocks 22 may blocks with horizontal and vertical dimensions that differ, such as 16×32 blocks, 16×64 blocks, or 8×128 blocks. The first matrix elements 23 may, for example, be FP8, FP6, or FP4 numbers. In other examples, the first matrix elements 23 may have some other format.

The input memory 13 is further configured to receive a second input matrix 24 including a plurality of second matrix elements 27. The second matrix elements 27 are organized into a plurality of second input blocks 26, which are sub-matrices of the second input matrix 24. The second input blocks 26 may, for example, be 16×16 blocks, 32×32 blocks, or 64×64 blocks. In other examples, the horizontal and vertical dimensions of the second input blocks 26 may differ from each other. Similarly to the first matrix elements 23, the format of the second matrix elements 27 may be FP8, FP6, or FP4. The second matrix elements 27 may have some other format in other examples.

The input memory 13 of the hardware accelerator 10 is further configured to receive a first block scale factor 28 and a second block scale factor 29. The first block scale factor 28 and the second block scale factor 29 may, for example, each be an eight-bit exponent, zero-bit mantissa (E8M0) number, a two-bit exponent, two-bit mantissa (E2M2) number, a five-bit exponent, three-bit mantissa (E5M3) number, a three-bit exponent, five-bit mantissa (E3M5) number, a two-bit exponent, zero-bit mantissa (E2M0) number, or a three-bit exponent, zero-bit mantissa (E3M0) number. Other data formats may be used for the first block scale factor 28 in some examples. The first block scale factor 28 is associated with rows of the first input block 22 and specifies a first predefined scale range 36. The second block scale factor 29 is associated with columns of the second input block 26 and specifies a second predefined scale range 37. The first block scale factor 28 may indicate a maximum value or a minimum value of the first predefined scale range 36, and the second block scale factor 29 may indicate a maximum value or minimum value of the second predefined scale range 37. The first and second predefined scale ranges 36 and 37 are ranges of eligible values that the first matrix elements 23 and the second matrix elements 27 may take after having been scaled by the first block scale factor 28 and the second block scale factor 29, respectively, in terms of the formats those matrix elements had prior to scaling. For example, a data format with a larger dynamic range than FP8 may be scaled to fit within the FP8 format, or a data format with a smaller dynamic range than FP8 may be scaled up to FP8 to provide increased precision. This scaling by the first block scale factor 28 and the second block scale factor 29 may be performed prior to inputting the first input block 22 and the second input block 26 into the hardware accelerator 10 or may alternatively be performed in a preprocessing step at the hardware accelerator 10.

At the processing circuitry 11, each tile 12 of the one or more tiles 12 is configured to receive a respective first input block 22 of the first input matrix 20 and a respective second input block 26 of the second input matrix 24. The one or more tiles 12 may each be further configured to receive the first block scale factor 28 and the second block scale factor 29, which, as discussed in further detail below, may be uniform across the one or more tiles 12 or may differ between tiles 12. Based at least in part on the first input block 22, the second input block 26, the first block scale factor 28, and the second block scale factor 29, each of the one or more tiles 12 is further configured to compute a respective scaled result block 30. The scaled result blocks 30 each include a plurality of result block elements 31 that are scaled to within a third scale range 38. The third scale range 38 is computed from the first block scale factor 28 and the second block scale factor 29 as discussed in further detail below.

The processing circuitry 11 of the hardware accelerator 10, as shown in the example of FIG. 2, further includes a first accumulator 32 configured to accumulate a plurality of scaled result blocks 30 to obtain a scaled result matrix 34. The scaled result matrix 34 includes a plurality of result matrix elements 35 computed by accumulating the result block elements 31. The scaled result matrix 34 is the result of multiplying the first input matrix 20 by the second input matrix 24 with the first block scale factor 28 and the second block scale factor 29 applied. Thus, both parameter scaling and matrix multiplication are performed at the hardware accelerator 10. The scaled result blocks 30 may be computed at the plurality of tiles 12 in examples in which the processing circuitry 11 includes a plurality of tiles 12. In examples in which the processing circuitry 11 includes a single tile 12, the plurality of scaled result blocks 30 may be computed at that tile 12.

As shown in FIG. 2, the output memory 14 is configured to receive and output the scaled result matrix 34. The scaled result matrix 34 may accordingly be processed at the one or more additional processing devices 2 and/or stored in the one or more memory devices 3 of the computing system 1. In some examples, as discussed below, the processing circuitry 11 is further configured to perform post-processing on the scaled result matrix 34 prior to outputting the scaled result matrix 34.

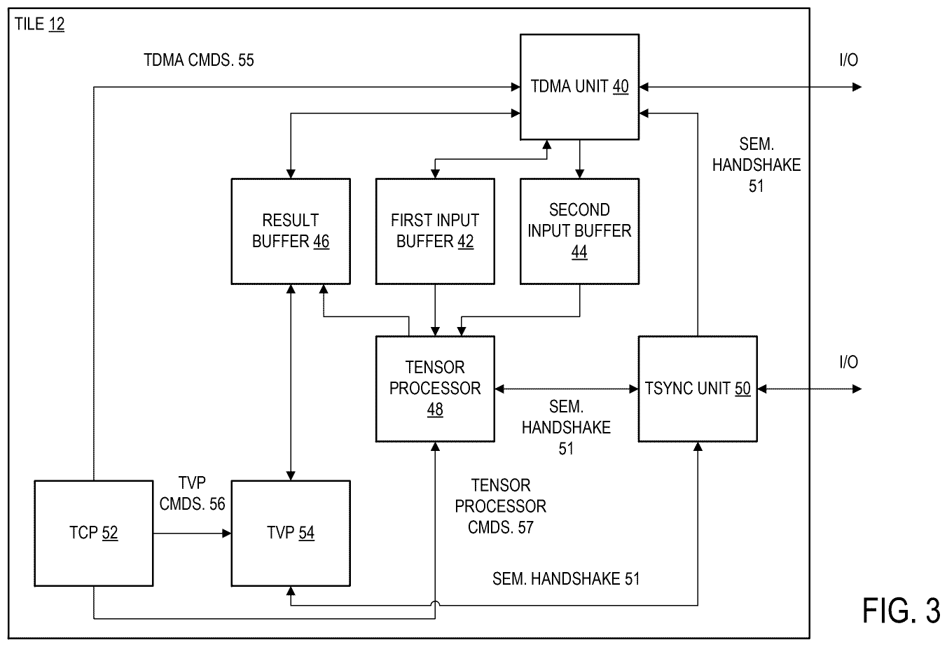

FIG. 3 schematically shows the components included in a tile 12 of the hardware accelerator 10, according to one example. The tile 12 shown in the example of FIG. 3 includes a tile direct memory access (TDMA) unit 40 via which the tile 12 is configured to perform DMA with other components of the hardware accelerator 10. For example, via the TDMA unit 40, the tile 12 may be configured to receive the first input block 22, the second input block 26, the first block scale factor 28, and the second block scale factor 29 from the input memory 13 and to output the scaled result block 30 to the first accumulator 32.

The tile 12 further includes a plurality of memory buffers, which include a first input buffer 42, a second input buffer 44, and a result buffer 46. The first input buffer 42, the second input buffer 44, and the result buffer 46 may each be tile static random-access memory (TSRAM), which may be level one (L1) memory. In the example of FIG. 3, the first input buffer 42 and the second input buffer 44 are configured to store inputs to a tensor processor 48 at which matrix multiplication is performed, as discussed in further detail below. The result buffer 46 is configured to store the scaled result block 30 that is generated when matrix multiplication is performed at the tensor processor 48. The first input buffer 42, the second input buffer 44, and the result buffer 46 are configured to communicate with the TDMA unit 40 to send and receive data via DMA.

The tile 12 further includes a tile synchronization (TSYNC) unit 50 that is configured to perform a semaphore handshake 51 between components of the tile 12 and other components of the hardware accelerator 10. The semaphore handshake 51 communicates signals between pairs of components that indicate when those components are ready to consume data. In the example of FIG. 3, endpoints of the semaphore handshake 51 may include the TDMA unit 40 and the tensor processor 48. Each semaphore handshake 51 may be internal to the tile 12 or between a component of the tile 12 and an external component of the hardware accelerator 10. External endpoints may, for example, include other tiles 12, the input memory 13, the output memory 14, and/or the controller 15.

The tile 12 shown in the example of FIG. 3 further includes a tile control processor (TCP) 52 and a TVP 54. The TCP 52 is configured to execute a kernel that instructs the TCP 52 to transmit commands to other components of the tile 12. Thus, the TCP 52 is configured to transmit TDMA commands 55 to the TDMA unit 40, TVP commands 56 to the TVP 54, and tensor processor commands 57 to the tensor processor 48. The TVP 54 is a within-tile hardware accelerator that is configured to perform one or more predefined vector operations on vectors stored in the result buffer 46. For example, the TVP 54 may be configured to apply an activation function or a SoftMax function to a vector stored in the result buffer 46. The TCP 52 and the TVP 54 may be endpoints of semaphore handshakes 51, as shown in the example of FIG. 3.

In previous hardware accelerators configured to perform scaled matrix multiplication, a scale factor is applied to the input data at a TVP. Unlike the TVP 54 shown in the example of FIG. 3, the TVPs of existing hardware accelerators are configured to apply the scale factor to the result matrix blocks. Since, in such hardware accelerators, the TVP performs both scaling and other post-processing operations on the result matrix blocks, the TVP frequently becomes oversubscribed, thereby slowing down the scaled matrix multiplication operation. In contrast, the hardware accelerator 10 disclosed herein is configured to apply the first block scale factor 28 and the second block scale factor 29 at the one or more tensor processors 48 included in the one or more tiles 12.

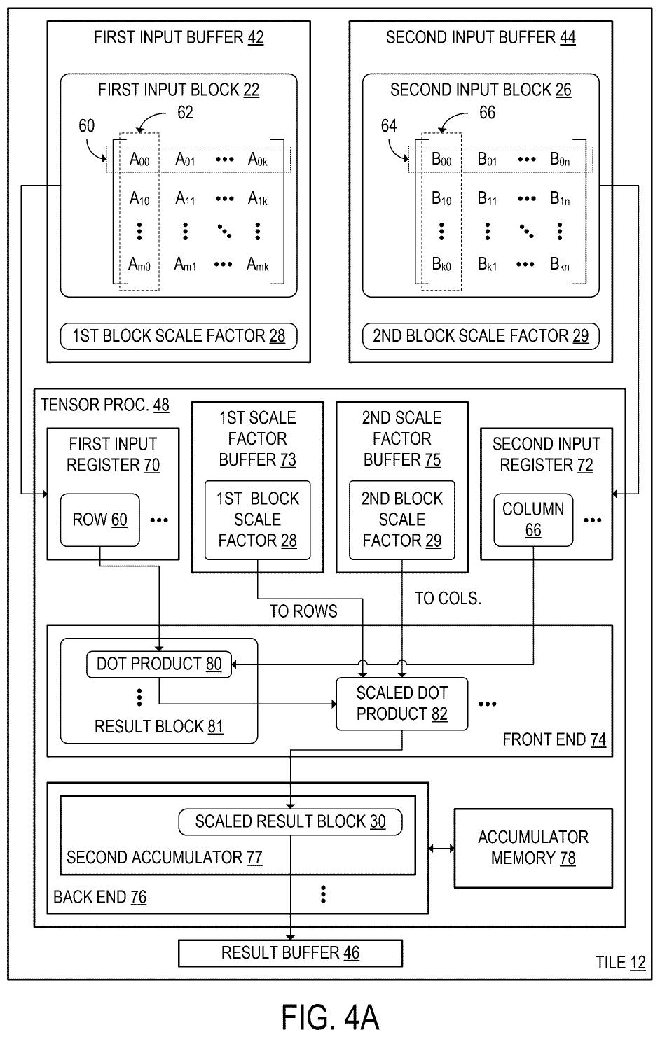

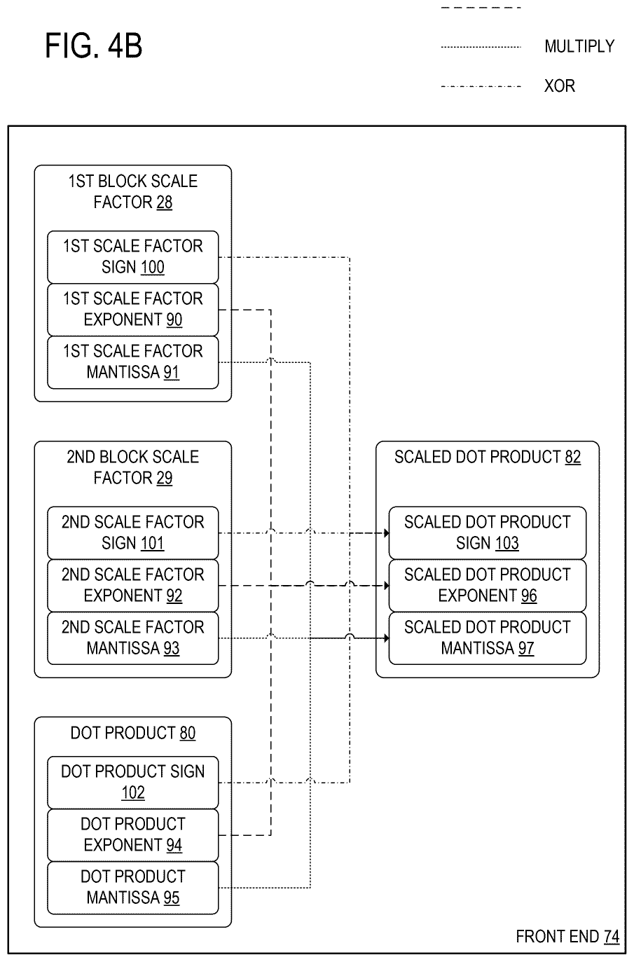

FIG. 4A schematically shows the tile 12 when matrix multiplication is performed and the first and second block scale factors 28 and 29 are applied at the tensor processor 48, according to one example. At each tile 12 of the one or more tiles 12, the respective tensor processor 48 is configured to receive the first input block 22 and the first block scale factor 28 from the first input buffer 42 included in that tile 12. In addition, the tensor processor 48 is further configured to receive the second input block 26 and the second block scale factor 29 from the second input buffer 44 included in the tile 12. In the example of FIG. 4A, the first input block 22 received at the first input buffer 42 is an m×k matrix organized into a plurality of rows 60 and columns 62. The second input block 26 stored at the second input buffer 44 is a k×n matrix that is organized into a plurality of rows 64 and a plurality of columns 66. Thus, the tensor processor 48 is configured to compute the scaled result block 30 as an m×n matrix.

The tensor processor 48, as shown in the example of FIG. 4A, includes a first input register 70, a second input register 72, a first scale factor buffer 73, and a second scale factor buffer 75. The first input register 70 is configured to receive the rows 60 of the first input block 22 in vector form, and the second input register 72 is configured to receive the columns 66 of the second input block 26 in vector form. Thus, the tile 12 is configured to prepare the first input block 22 and the second input block 26 for dot product computation. The first scale factor buffer 73 is configured to receive the first block scale factor 28 from the first input buffer 42, and the second scale factor buffer 75 is configured to receive the second block scale factor 29 from the second input buffer 44.

The tensor processor 48 further includes a front end 74. At the front end 74, the tensor processor 48 is configured to multiply the first input block 22 by the second input block 26 to obtain a result block 81. The result block 81 includes a plurality of dot products 80 that are each computed as a dot product of a row 60 of the first input block 22 and a column 66 of the second input block 26. In the example of FIG. 4A, the result block 81 is distributed among a plurality of dot product units included in the front end 74, which discussed in further detail below, rather than being stored at a single buffer.

At the front end 74, the tensor processor 48 is further configured to apply the first block scale factor 28 to rows of the result block 81 and apply the second block scale factor 29 to columns of the result block 81. Accordingly, the front end 74 computes a plurality of scaled dot products 82.

FIG. 4B schematically shows the front end 74 in additional detail when a scaled dot product 82 is computed. As shown in FIG. 4B, the first block scale factor 28 includes a first scale factor exponent 90 and a first scale factor mantissa 91. The second block scale factor 29 includes a second scale factor exponent 92 and a second scale factor mantissa 93. The dot product 80 includes a dot product exponent 94 and a dot product mantissa 95. The front end 74 is configured to apply the first block scale factor 28 and the second block scale factor 29 to each of the dot products 80 at least in part by adding the respective exponents 90, 92, and 94 of the first block scale factor 28, the second block scale factor 29, and the dot product 80 to obtain a scaled dot product exponent 96 of the scaled dot product 82. In addition, the front end 74 is configured to multiply the respective mantissas 91, 93, and 95 of the first block scale factor 28, the second block scale factor 29, and the dot product 80 to obtain a scaled dot product mantissa 97 of the scaled dot product 82.

In some examples, as shown in FIG. 4B, the first block scale factor 28, the second block scale factor 29, and the dot product 80 include respective signs 100, 101, and 102. In such examples, the front end 74 is configured to apply the first block scale factor 28 and the second block scale factor 29 to each of the dot products 80 at least in part by computing an exclusive or (XOR) of the respective signs 100, 101, and 102 of the first block scale factor 28, the second block scale factor 29, and the dot product 80. The front end 74 is accordingly configured to obtain a scaled dot product sign 103 of the scaled dot product 82.

Returning to FIG. 4A, in some examples, each of the tensor processors 48 further includes a respective back end 76 that includes a plurality of second accumulators 77. In addition, the tensor processor 48 shown in FIG. 4 includes accumulator memory 78 configured to be utilized by the second accumulators 77. At the plurality of second accumulators 77, the tensor processor 48 is further configured to accumulate the scaled dot products 82, thereby computing the scaled result block 30. The tensor processor 48 is further configured to output the scaled result block 30 to the result buffer 46 of the tile 12.

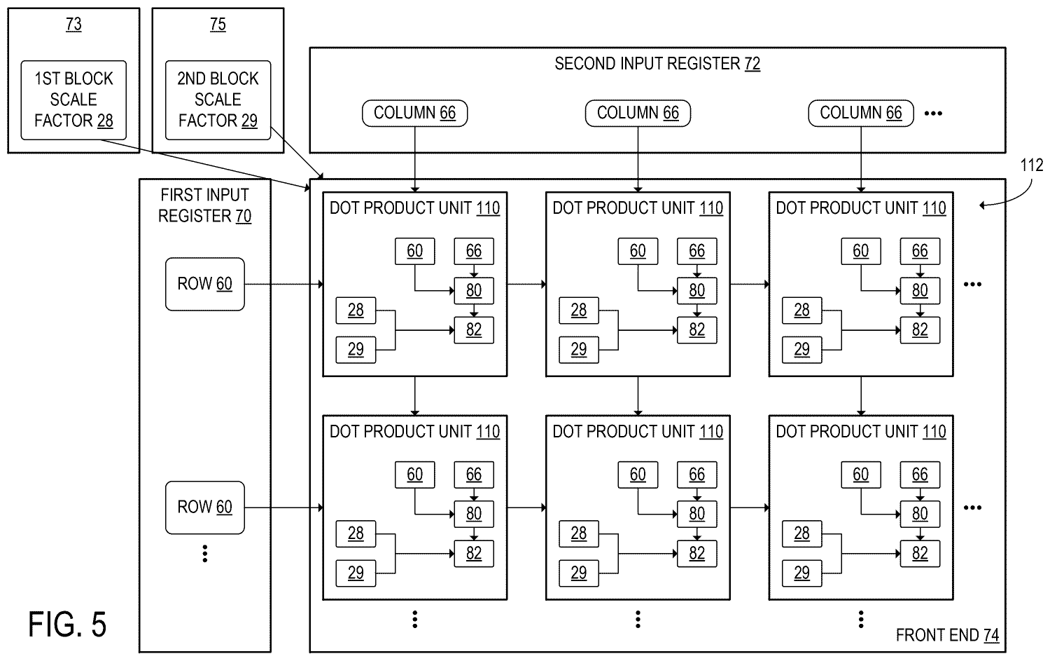

FIG. 5 schematically shows the front end 74 of the tensor processor 48 in additional detail, according to one example. In the example of FIG. 5, each of the tensor processors 48 includes a respective dot product array 112 of a plurality of dot product units 110. In the example of FIG. 5, the dot product array 112 is a systolic array in which the dot product units 110 are arranged in a rectangular grid.

Each of the dot product units 110 is configured to receive the first block scale factor 28 stored in the first scale factor buffer 73 and the second block scale factor 29 stored in the second scale factor buffer 75. In addition, each of the dot product units 110 is further configured to receive a respective row 60 of the first input block 22 and a respective column 66 of the second input block 26. The dot product units 110 are each configured to compute the dot product 80 of the respective row 60 and column 66 that they receive, and to apply the first block scale factor 28 and the second block scale factor 29 to the dot product 80 to obtain the scaled dot product 82. Each dot product unit 110 is further configured to output the scaled dot product 82. Accordingly, the dot product units 110 included in the front end 74 are configured to compute and output the scaled dot products 82 that are accumulated to obtain the scaled result block 30.

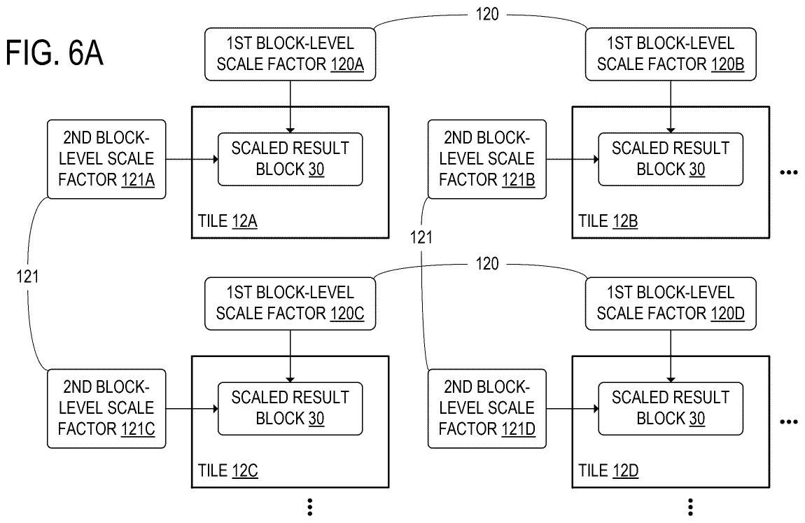

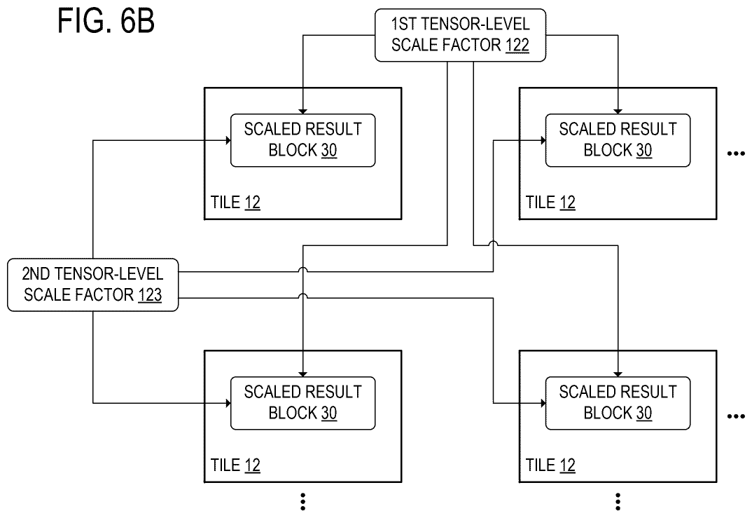

FIG. 6A shows an example in which the first block scale factor 28 and the second block scale factor 29 are block-level scale factors 120 and 121, respectively. The processing circuitry 11 includes a plurality of the tiles 12 in the example of FIG. 6A. The tiles 12 are each configured to receive a respective first block-level scale factor 120 and a second block-level scale factor 121. The first block-level scale factor 120 is applied to each of the rows 60 of the first input block 22, and the second block-level scale factor 121 is applied to each of the columns 66 of the second input block 26. The processing circuitry 11 is configured to apply a plurality of different block-level scale factors 120 and 121 at corresponding tiles 12 of the plurality of tiles 12. FIG. 6A shows first block-level scale factors 120A, 120B, 120C, and 120D that are applied to tiles 12A, 12B, 12C, and 12D respectively. In addition, second block-level scale factors 121A, 121B, 121C, and 121D are respectively applied at the tiles 12A, 12B, 12C, and 12D in the example of FIG. 6A. In other examples, a plurality of different block-level scale factors may be applied at a single tile 12.

FIG. 6B shows an example in which the first block scale factor 28 and second block scale factor 29 are tensor-level scale factors 122 and 123. The first tensor-level scale factor 122 is applied to each of the rows 60 of each of the first input blocks 22, and the second tensor-level scale factor 123 is applied to each of the columns 66 of each of the second input blocks 26. Accordingly, the tensor-level scale factors 122 and 123 are applied to the entire first input matrix 20 and the entire second input matrix 24.

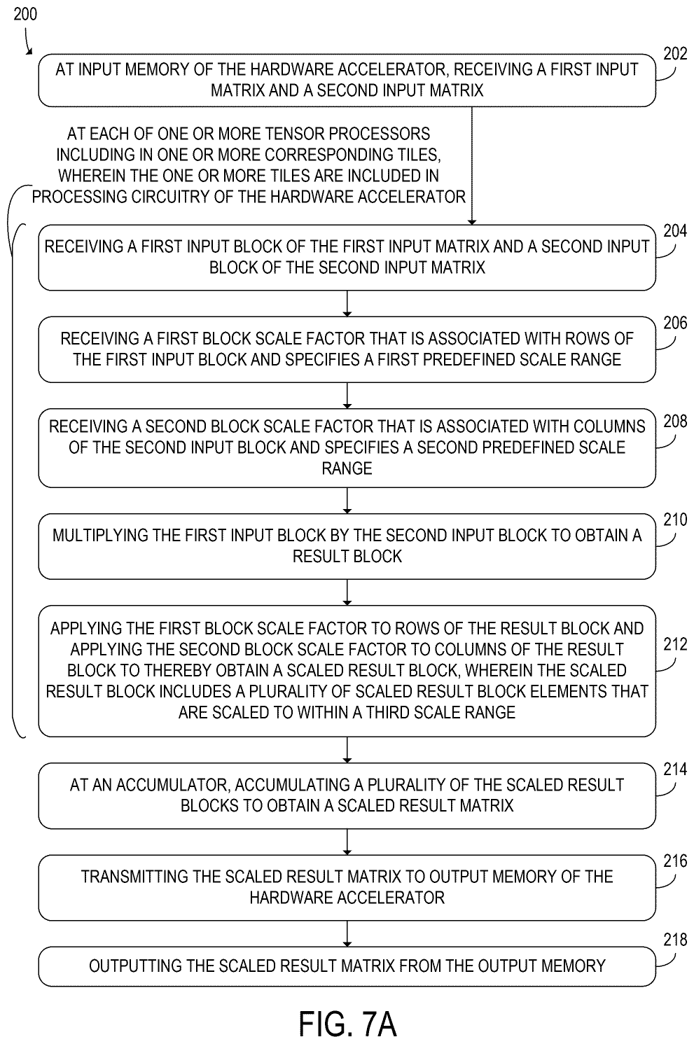

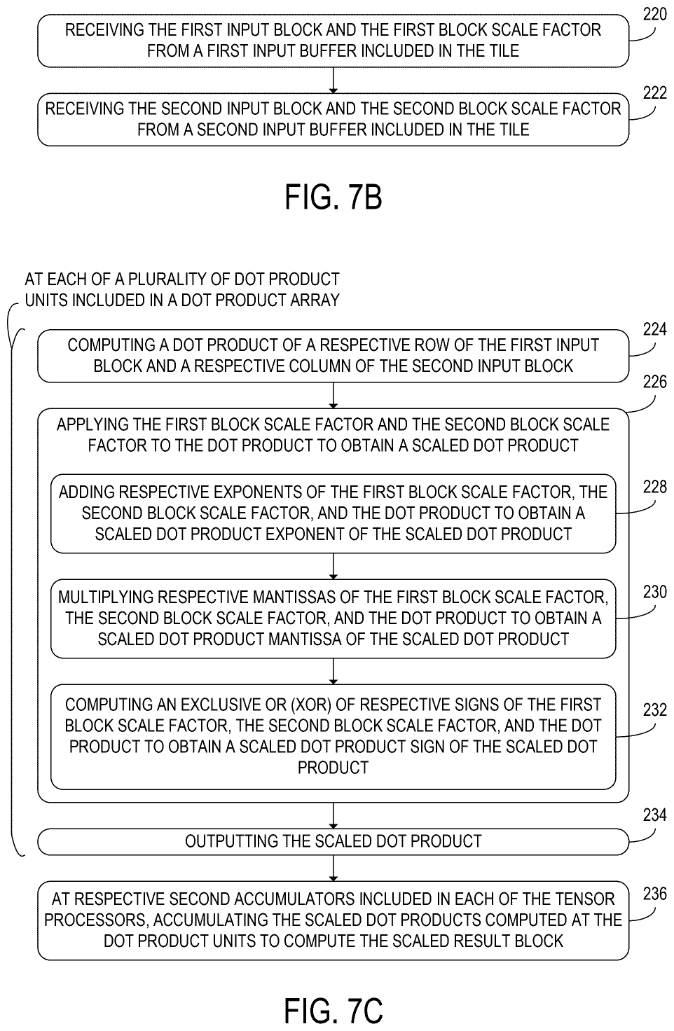

FIG. 7A shows a flowchart of a method 200 for use with a hardware accelerator to perform a scaled matrix multiply operation. At step 202, the method 200 includes receiving a first input matrix including a plurality of first matrix elements and a second input matrix including a plurality of second matrix elements. Step 202 is performed at input memory of the hardware accelerator. The first matrix elements and the second matrix elements may be floating-point numbers. For example, the first matrix elements and the second matrix elements may have the FP8, FP6, or FP4 format. The first matrix elements and the second matrix elements may be parameters, activations, or gradients of a neural network in some examples.

Steps 204, 206, 208, 210, and 212 of the method 200 may be performed at each of one or more tensor processors including in one or more corresponding tiles. The one or more tiles are included in processing circuitry of the hardware accelerator. At step 204, the method 200 may include receiving a first input block of the first input matrix and a second input block of the second input matrix. The first input block and the second input block are sub-matrices of the first input matrix and the second input matrix, respectively. For example, the first input block and the second input block may each be a 16×16 block, a 32×32 block, or a 64×64 block. Alternatively, the first input block and the second input block may have horizontal and vertical dimensions that differ from each other.

At step 206, the method 200 further includes receiving a first block scale factor that is associated with rows of the first input block and specifies a first predefined scale range. For example, the scale factor may indicate a maximum value or minimum value of a first predefined scale range. The first block scale factor may be an E8M0 number, an E2M2 number, an E5M3 number, an E3M5 number, an E2M0 number, or an E3M0 number in some examples. Some other floating-point representation may alternatively be used in other examples. Accordingly, by rescaling the first matrix elements, precision is maintained for first matrix elements that have been compressed into a smaller floating-point format from a format such as FP32, FP16, or Bfloat16.

At step 208, the method 200 further includes receiving a second block scale factor that is associated with columns of the second input block and specifies a second predefined scale range. The second block scale factor may indicate a maximum value or a minimum value of a second predefined scale range. Similarly to the first block scale factor, the second block scale factor may be an E8M0 number, an E2M2 number, an E5M3 number, an E3M5 number, an E2M0 number, an E3M0 number, or a floating-point number with some other representation.

At step 210, the method 200 further includes multiplying the first input block by the second input block to obtain a result block. The result block elements of the result block may be computed at respective dot product units included in dot product arrays. Each of the one or more tiles of the processing circuitry may include a respective dot product array in such examples.

At step 212, the method 200 further includes applying the first block scale factor to rows of the result block and applying the second block scale factor to columns of the result block to thereby obtain a scaled result block. The scaled result block includes a plurality of scaled result block elements that are scaled to within a third scale range. The third scale range may be obtained by combining the first block scale factor and the second block scale factor, as discussed in further detail below. The first block scale factor and the second block scale factor are applied to the result block elements at the dot product units. Accordingly, tensor multiplication and scaling are both performed at the tensor processor. Performing tensor scaling at the tensor processor instead of at the TVP may reduce TVP oversubscription, thereby accelerating scaled matrix multiplication.

At step 214, the method 200 further includes accumulating a plurality of scaled result blocks to obtain a scaled result matrix. The scaled result blocks may be computed at a plurality of tiles that each perform steps 204 through 212, or alternatively at a single tile that performs steps 204 through 212 multiple times. The scaled result matrix is computed at an accumulator included in the hardware accelerator. Accordingly, the scaled result matrix is computed by summing the scaled result blocks computed at the tiles from respective first input blocks and second input blocks.

In some examples, the first block scale factor and the second block scale factor may be block-level scale factors that are respectively applied to each of the rows and each of the columns of the result block. In such examples, when the hardware accelerator includes a plurality of tiles, a plurality of different block-level scale factors are applied at corresponding tiles of the plurality of tiles. Thus, the scaled result blocks computed at those tiles are scaled to within different predefined scale ranges. Alternatively, a plurality of different block-level scale factors may be applied at the same tile. In other examples, the first block scale factor and the second block scale factors are tensor-level scale factors that are respectively applied to the rows and the columns of each of the result blocks. Thus, the same block scale factors are used to compute the entire result matrix in such examples.

At step 216, the method 200 further includes transmitting the scaled result matrix to output memory of the hardware accelerator. At step 218, the method 200 further includes outputting the scaled result matrix from the output memory. Accordingly, the scaled result matrix may be utilized at other components of the computing system in which the hardware accelerator is located.

FIG. 7B shows additional steps of the method 200 that may be performed at the tensor processor in some examples. The steps of FIG. 7B may be performed when the tensor processor receives the input matrices and block scale factors at steps 204, 206, and 208. At step 220, the method may include receiving the first input block and the first block scale factor from a first input buffer included in the tile. At step 222, the method 200 may further include receiving the second input block and the second block scale factor from a second input buffer included in the tile. The tensor processor may, in some examples, store rows of the first input block at a first input register, columns of the second input block at a second input register, the first block scale factor at a first scale factor buffer, and the second block scale factor at a second scale factor buffer. The tensor processor may load the rows, columns, and block scale factors into the dot product units from those buffers.

FIG. 7C shows additional steps of the method 200 that may be performed at the tensor processor in some examples. In the example of FIG. 7C, the tensor processor includes a respective dot product array of a plurality of dot product units. Steps 224, 226, 228, 230, 232, and 234, as shown in FIG. 7C, may be performed at each of the dot product units included in the dot product array. At step 224, the method 200 may include, at each of the dot product units, computing a dot product of a respective row of the first input block and a respective column of the second input block. At step 226, the method 200 may further include applying the first block scale factor and the second block scale factor to the dot product to obtain a scaled dot product.

Steps 228, 230, and 232 may be performed when the scaled dot product is computed at step 226. At step 228, step 226 may include adding respective exponents of the first block scale factor, the second block scale factor, and the dot product to obtain a scaled dot product exponent of the scaled dot product. At step 230, step 226 may include multiplying respective mantissas of the first block scale factor, the second block scale factor, and the dot product to obtain a scaled dot product mantissa of the scaled dot product. In examples in which the first block scale factor, the second block scale factor, and the dot product include respective signs, step 226 may further include step 232. At step 232, applying the first block scale factor and the second block scale factor to each of the dot products may include computing an XOR of the respective signs of the first block scale factor, the second block scale factor, and the dot product to obtain a scaled dot product sign of the scaled dot product.

At step 234, the method 200 further include outputting the scaled dot product from the dot product unit of the tensor processor. FIG. 7C further shows step 236, which may be performed a plurality of second accumulators included in each of the tensor processors. At step 236, the method 200 may further include accumulating the scaled dot products computed at the dot product units to compute the scaled result block. Thus, the scaled result block may be computed by performing a plurality of scaled dot products in parallel and accumulating those scaled dot products.

Using the devices and methods discussed above, scaled matrix multiplication operations may be performed at a hardware accelerator in a manner in which both matrix multiplication and scaling are performed at the tensor processors included in one or more tiles of the processing circuitry. By performing matrix multiplication and scaling at the tensor processor, the workload of a tile vector processor (e.g., a SIMD or SIMT tile vector processor) included in the tile may be reduced. This reduction in TVP workload may allow the scaled matrix multiplication operation to be performed more quickly, since vector processing at the TVP frequently acts as a bottleneck during scaled matrix multiplication. This speedup may allow training and inferencing to be performed more quickly and efficiently at machine learning models.

In some embodiments, the methods and processes described herein may be tied to a computing system of one or more computing devices. In particular, such methods and processes may be implemented as a computer-application program or service, an application-programming interface (API), a library, and/or other computer-program product.

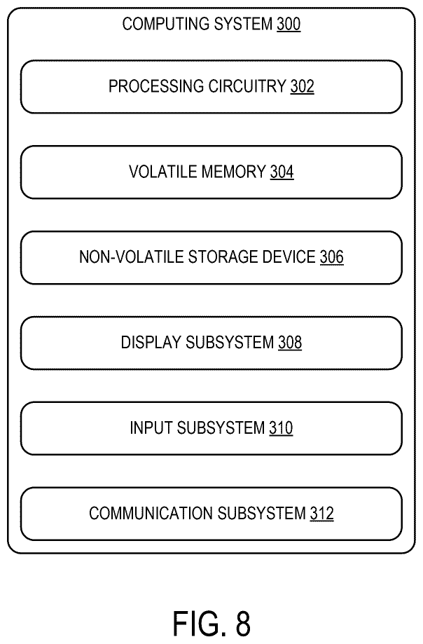

FIG. 8 schematically shows a non-limiting embodiment of a computing system 300 that can enact one or more of the methods and processes described above. Computing system 300 is shown in simplified form. Computing system 300 may embody the computing system 1 described above and illustrated in FIG. 1. Components of computing system 300 may be included in one or more personal computers, server computers, tablet computers, home-entertainment computers, network computing devices, video game devices, mobile computing devices, mobile communication devices (e.g., smartphone), and/or other computing devices, and wearable computing devices such as smart wristwatches and head mounted augmented reality devices.

Computing system 300 includes a logic processor 302 volatile memory 304, and a non-volatile storage device 306. Computing system 300 may optionally include a display subsystem 308, input subsystem 310, communication subsystem 312, and/or other components not shown in FIG. 8.

Logic processor 302 includes one or more physical devices configured to execute instructions. For example, the logic processor may be configured to execute instructions that are part of one or more applications, programs, routines, libraries, objects, components, data structures, or other logical constructs. Such instructions may be implemented to perform a task, implement a data type, transform the state of one or more components, achieve a technical effect, or otherwise arrive at a desired result.

The logic processor may include one or more physical processors configured to execute software instructions. Additionally or alternatively, the logic processor may include one or more hardware logic circuits or firmware devices configured to execute hardware-implemented logic or firmware instructions. Processors of the logic processor 302 may be single-core or multi-core, and the instructions executed thereon may be configured for sequential, parallel, and/or distributed processing. Individual components of the logic processor optionally may be distributed among two or more separate devices, which may be remotely located and/or configured for coordinated processing. Aspects of the logic processor may be virtualized and executed by remotely accessible, networked computing devices configured in a cloud-computing configuration. In such a case, these virtualized aspects are run on different physical logic processors of various different machines, it will be understood.

Non-volatile storage device 306 includes one or more physical devices configured to hold instructions executable by the logic processors to implement the methods and processes described herein. When such methods and processes are implemented, the state of non-volatile storage device 306 may be transformed—e.g., to hold different data.

Non-volatile storage device 306 may include physical devices that are removable and/or built in. Non-volatile storage device 306 may include optical memory, semiconductor memory, and/or magnetic memory, or other mass storage device technology. Non-volatile storage device 306 may include nonvolatile, dynamic, static, read/write, read-only, sequential-access, location-addressable, file-addressable, and/or content-addressable devices. It will be appreciated that non-volatile storage device 306 is configured to hold instructions even when power is cut to the non-volatile storage device 306.

Volatile memory 304 may include physical devices that include random access memory. Volatile memory 304 is typically utilized by logic processor 302 to temporarily store information during processing of software instructions. It will be appreciated that volatile memory 304 typically does not continue to store instructions when power is cut to the volatile memory 304.

Aspects of logic processor 302, volatile memory 304, and non-volatile storage device 306 may be integrated together into one or more hardware-logic components. Such hardware-logic components may include field-programmable gate arrays (FPGAs), program-and application-specific integrated circuits (PASIC/ASICs), program-and application-specific standard products (PSSP/ASSPs), system-on-a-chip (SOC), and complex programmable logic devices (CPLDs), for example.

The terms “module,” “program,” and “engine” may be used to describe an aspect of computing system 300 typically implemented in software by a processor to perform a particular function using portions of volatile memory, which function involves transformative processing that specially configures the processor to perform the function. Thus, a module, program, or engine may be instantiated via logic processor 302 executing instructions held by non-volatile storage device 306, using portions of volatile memory 304. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

When included, display subsystem 308 may be used to present a visual representation of data held by non-volatile storage device 306. The visual representation may take the form of a graphical user interface (GUI). As the herein described methods and processes change the data held by the non-volatile storage device, and thus transform the state of the non-volatile storage device, the state of display subsystem 308 may likewise be transformed to visually represent changes in the underlying data. Display subsystem 308 may include one or more display devices utilizing virtually any type of technology. Such display devices may be combined with logic processor 302, volatile memory 304, and/or non-volatile storage device 306 in a shared enclosure, or such display devices may be peripheral display devices.

When included, input subsystem 310 may comprise or interface with one or more user-input devices such as a keyboard, mouse, touch screen, camera, or microphone.

When included, communication subsystem 312 may be configured to communicatively couple various computing devices described herein with each other, and with other devices. Communication subsystem 312 may include wired and/or wireless communication devices compatible with one or more different communication protocols. As non-limiting examples, the communication subsystem may be configured for communication via a wired or wireless local-or wide-area network, broadband cellular network, etc. In some embodiments, the communication subsystem may allow computing system 300 to send and/or receive messages to and/or from other devices via a network such as the Internet.

The following paragraphs discuss several aspects of the present disclosure. According to one aspect of the present disclosure, a hardware accelerator is provided, including input memory configured to receive a first input matrix and a second input matrix. The hardware accelerator further includes processing circuitry including one or more tiles. Each tile of the one or more tiles includes a respective tensor processor configured to receive a first input block of the first input matrix and a second input block of the second input matrix. The tensor processor is further configured to receive a first block scale factor that is associated with rows of the first input block and specifies a first predefined scale range and receive a second block scale factor that is associated with columns of the second input block and specifies a second predefined scale range. The tensor processor is further configured to multiply the first input block by the second input block to obtain a result block. The tensor processor is further configured to apply the first block scale factor to rows of the result block and apply the second block scale factor to columns of the result block to thereby obtain a scaled result block. The scaled result block includes a plurality of scaled result block elements that are scaled to within a third scale range. The hardware accelerator further includes an accumulator configured to accumulate a plurality of the scaled result blocks to obtain a scaled result matrix. The hardware accelerator further includes output memory configured to receive and output the scaled result matrix. The above features may have the technical effect of performing both multiplication and scaling at the tensor processor, thereby reducing the workload of a tile vector processor. Reducing the workload of the tile vector processor may increase the efficiency of computing the scaled result matrix.

According to this aspect, the processing circuitry may include a plurality of the tiles. The above features may have the technical effect of computing multiple scaled result matrices in parallel.

According to this aspect, the first block scale factor and the second block scale factor may be block-level scale factors. The processing circuitry may be configured to apply a plurality of different block-level scale factors at the one or more tiles. The above features may have the technical effect of flexibly scaling different portions of the first input tensor and the second input tensor by different quantities.

According to this aspect, the first block scale factor and the second block scale factor may be tensor-level scale factors that are associated with each of the first input blocks included in the first input matrix and with each of the second input blocks included in the second input matrix, respectively. The above features may have the technical effect of applying the tensor-level scale factors to the result blocks in parallel.

According to this aspect, the first block scale factor and the second block scale factor may each be an eight-bit exponent, zero-bit mantissa (E8M0) number, a two-bit exponent, two-bit mantissa (E2M2) number, a five-bit exponent, three-bit mantissa (E5M3) number, a three-bit exponent, five-bit mantissa (E3M5) number, a two-bit exponent, zero-bit mantissa (E2M0) number, or a three-bit exponent, zero-bit mantissa (E3M0) number. The above features may have the technical effect of allowing a variety of different formats to be used for the scale factors.

According to this aspect, the tensor processor may include a respective dot product array of a plurality of dot product units. Each of the dot product units may be configured to compute a dot product of a respective row of the first input block and a respective column of the second input block. Each of the dot product units may be further configured to apply the first block scale factor and the second block scale factor to the dot product to obtain a scaled dot product. Each of the dot product units may be further configured to output the scaled dot product. The above features may have the technical effect of computing the scaled dot products in parallel within the tensor processor, thereby allowing the result block to be computed more efficiently.

According to this aspect, the processing circuitry is configured to apply the first block scale factor and the second block scale factor to each of the dot products at least in part by adding respective exponents of the first block scale factor, the second block scale factor, and the dot product to obtain a scaled dot product exponent of the scaled dot product. Applying the first block scale factor and the second block scale factor further includes multiplying respective mantissas of the first block scale factor, the second block scale factor, and the dot product to obtain a scaled dot product mantissa of the scaled dot product. The above features may have the technical effect of computing the scaled dot products in parallel.

According to this aspect, the first block scale factor, the second block scale factor, and the dot product may include respective signs. The processing circuitry may be configured to apply the first block scale factor and the second block scale factor to each of the dot products at least in part by computing an exclusive or (XOR) of the respective signs of the first block scale factor, the second block scale factor, and the dot product to obtain a scaled dot product sign of the scaled dot product. The above features may have the technical effect of computing the signs of the scaled dot products in parallel at the dot product units.

According to this aspect, the tensor processor may be configured to receive the first input block and the first block scale factor from a first input buffer included in the tile. The tensor processor may be further configured to receive the second input block and the second block scale factor from a second input buffer included in the tile. The above features may have the technical effect of storing the input blocks at the tile prior to multiplication.

According to another aspect of the present disclosure, a method for use with a hardware accelerator is provided. The method may include, at input memory of the hardware accelerator, receiving a first input matrix and a second input matrix. The method may further include, at each of one or more tensor processors including in one or more corresponding tiles, wherein the one or more tiles are included in processing circuitry of the hardware accelerator, receiving a first input block of the first input matrix and a second input block of the second input matrix. The method may further include receiving a first block scale factor that is associated with rows of the first input block and specifies a first predefined scale range and receiving a second block scale factor that is associated with columns of the second input block and specifies a second predefined scale range. The method may further include multiplying the first input block by the second input block to obtain a result block. The method may further include applying the first block scale factor to rows of the result block and applying the second block scale factor to columns of the result block to thereby obtain a scaled result block. The scaled result block may includes a plurality of scaled result block elements that are scaled to within a third scale range. At an accumulator, the method may further include accumulating a plurality of the scaled result blocks to obtain a scaled result matrix. The method may further include transmitting the scaled result matrix to output memory of the hardware accelerator and outputting the scaled result matrix from the output memory. The above features may have the technical effect of performing both multiplication and scaling at the tensor processor, thereby reducing the workload of a tile vector processor. Reducing the workload of the tile vector processor may increase the efficiency of computing the scaled result matrix.

According to this aspect, the processing circuitry may include a plurality of the tiles. The above features may have the technical effect of computing multiple scaled result matrices in parallel.

According to this aspect, the first block scale factor and the second block scale factor may be block-level scale factors. A plurality of different block-level scale factors may be applied at the one or more tiles. The above features may have the technical effect of flexibly scaling different portions of the first input tensor and the second input tensor by different quantities.

According to this aspect, the first block scale factor and the second block scale factor may be tensor-level scale factors that are associated with each of the first input blocks included in the first input matrix and with each of the second input blocks included in the second input matrix, respectively. The above features may have the technical effect of applying the tensor-level scale factors to the result blocks in parallel.

According to this aspect, the first block scale factor and the second block scale factor may each be an eight-bit exponent, zero-bit mantissa (E8M0) number, a two-bit exponent, two-bit mantissa (E2M2) number, a five-bit exponent, three-bit mantissa (E5M3) number, a three-bit exponent, five-bit mantissa (E3M5) number, a two-bit exponent, zero-bit mantissa (E2M0) number, or a three-bit exponent, zero-bit mantissa (E3M0) number. The above features may have the technical effect of allowing a variety of different formats to be used for the scale factors.

According to this aspect, the tensor processor may include a respective dot product array of a plurality of dot product units. At each of the dot product units, the method may further include computing a dot product of a respective row of the first input block and a respective column of the second input block. The method may further include applying the first block scale factor and the second block scale factor to the dot product to obtain a scaled dot product. The method may further include outputting the scaled dot product. The above features may have the technical effect of computing the scaled dot products in parallel within the tensor processor, thereby allowing the result block to be computed more efficiently.

According to this aspect, applying the first block scale factor and the second block scale factor to each of the dot products may include adding respective exponents of the first block scale factor, the second block scale factor, and the dot product to obtain a scaled dot product exponent of the scaled dot product. Applying the first block scale factor and the second block scale factor may further include multiplying respective mantissas of the first block scale factor, the second block scale factor, and the dot product to obtain a scaled dot product mantissa of the scaled dot product. The above features may have the technical effect of computing the scaled dot products in parallel.

According to this aspect, the first block scale factor, the second block scale factor, and the dot product may include respective signs. Applying the first block scale factor and the second block scale factor to each of the dot products may include computing an exclusive or (XOR) of the respective signs of the first block scale factor, the second block scale factor, and the dot product to obtain a scaled dot product sign of the scaled dot product. The above features may have the technical effect of computing the signs of the scaled dot products in parallel at the dot product units.

According to this aspect, the method may further include, at the tensor processor, receiving the first input block and the first block scale factor from a first input buffer included in the tile. The method may further include receiving the second input block and the second block scale factor from a second input buffer included in the tile. The above features may have the technical effect of storing the input blocks prior to multiplication.

According to another aspect of the present disclosure, a tile included in processing circuitry of a hardware accelerator is provided. The tile includes a first input register configured to receive a first input block of a first input matrix. The tile further includes a second input register configured to receive a second input block of a second input matrix. The tile further includes a first scale factor buffer configured to receive a first block scale factor that is associated with rows of the first input block and specifies a first predefined scale range. The tile further includes a second scale factor buffer configured to receive a second block scale factor that is associated with columns of the second input block and specifies a second predefined scale range. The tile further includes a dot product array of a plurality of dot product units. Each of the dot product units is configured to compute a dot product of a respective row of the first input block and a respective column of the second input block. Each of the dot product units is further configured to apply the first block scale factor and the second block scale factor to the dot product to obtain a scaled dot product that is scaled to within a third scale range. Each of the dot product units is configured to output the scaled dot product. The tile further includes an accumulator configured to accumulate the scaled dot products computed at the dot product units to compute a scaled result block. The tile further includes a result buffer configured to receive and output the scaled result block. The above features may have the technical effect of performing both multiplication and scaling at the dot product units included in the tile, thereby reducing the workload of a tile vector processor. Reducing the workload of the tile vector processor may increase the efficiency of performing matrix multiplication.

According to this aspect, the dot product array may be configured to apply the first block scale factor and the second block scale factor to each of the dot products at least in part by adding respective exponents of the first block scale factor, the second block scale factor, and the dot product to obtain a scaled dot product exponent of the scaled dot product. Applying the first block scale factor and the second block scale factor may further include multiplying respective mantissas of the first block scale factor, the second block scale factor, and the dot product to obtain a scaled dot product mantissa of the scaled dot product. The above features may have the technical effect of computing the exponent and mantissa of the scaled dot product.

“And/or” as used herein is defined as the inclusive or V, as specified by the following truth table:

| A | B | A ∨ B |
|---|---|---|
| True | True | True |
| True | False | True |
| False | True | True |
| False | False | False |

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A hardware accelerator, comprising:
input memory configured to receive a first input matrix and a second input matrix; and
processing circuitry including one or more tiles, each tile of the one or more tiles including a respective tensor processor configured to:
receive a first input block of the first input matrix and a second input block of the second input matrix;
receive a first block scale factor that is associated with rows of the first input block and specifies a first predefined scale range;
receive a second block scale factor that is associated with columns of the second input block and specifies a second predefined scale range;
multiply the first input block by the second input block to obtain a result block; and
apply the first block scale factor to rows of the result block and apply the second block scale factor to columns of the result block to thereby obtain a scaled result block, wherein the scaled result block includes a plurality of scaled result block elements that are scaled to within a third scale range;
an accumulator configured to accumulate a plurality of the scaled result blocks to obtain a scaled result matrix; and
output memory configured to receive and output the scaled result matrix.

2. The hardware accelerator of claim 1, wherein the processing circuitry includes a plurality of the tiles.

3. The hardware accelerator of claim 1, wherein:
the first block scale factor and the second block scale factor are block-level scale factors; and
the processing circuitry is configured to apply a plurality of different block-level scale factors at the one or more tiles.

4. The hardware accelerator of claim 1, wherein the first block scale factor and the second block scale factor are tensor-level scale factors that are associated with each of the first input blocks included in the first input matrix and with each of the second input blocks included in the second input matrix, respectively.

5. The hardware accelerator of claim 1, wherein the first block scale factor and the second block scale factor are each:
an eight-bit exponent, zero-bit mantissa (E8M0) number;
a two-bit exponent, two-bit mantissa (E2M2) number;
a five-bit exponent, three-bit mantissa (E5M3) number;
a three-bit exponent, five-bit mantissa (E3M5) number;
a two-bit exponent, zero-bit mantissa (E2M0) number; or
a three-bit exponent, zero-bit mantissa (E3M0) number.

6. The hardware accelerator of claim 1, wherein:
the tensor processor includes a dot product array of a plurality of dot product units; and
each of the dot product units is configured to:
compute a dot product of a respective row of the first input block and a respective column of the second input block;
apply the first block scale factor and the second block scale factor to the dot product to obtain a scaled dot product; and
output the scaled dot product.

7. The hardware accelerator of claim 6, wherein the processing circuitry is configured to apply the first block scale factor and the second block scale factor to each of the dot products at least in part by:
adding respective exponents of the first block scale factor, the second block scale factor, and the dot product to obtain a scaled dot product exponent of the scaled dot product; and
multiplying respective mantissas of the first block scale factor, the second block scale factor, and the dot product to obtain a scaled dot product mantissa of the scaled dot product.

8. The hardware accelerator of claim 6, wherein:
the first block scale factor, the second block scale factor, and the dot product include respective signs; and
the processing circuitry is configured to apply the first block scale factor and the second block scale factor to each of the dot products at least in part by computing an exclusive or (XOR) of the respective signs of the first block scale factor, the second block scale factor, and the dot product to obtain a scaled dot product sign of the scaled dot product.

9. The hardware accelerator of claim 1, wherein the tensor processor is configured to:
receive the first input block and the first block scale factor from a first input buffer included in the tile; and
receive the second input block and the second block scale factor from a second input buffer included in the tile.

10. A method for use with a hardware accelerator, the method comprising:
at input memory of the hardware accelerator, receiving a first input matrix and a second input matrix; and
at each of one or more tensor processors including in one or more corresponding tiles, wherein the one or more tiles are included in processing circuitry of the hardware accelerator:
receiving a first input block of the first input matrix and a second input block of the second input matrix;
receiving a first block scale factor that is associated with rows of the first input block and specifies a first predefined scale range;
receiving a second block scale factor that is associated with columns of the second input block and specifies a second predefined scale range;
multiplying the first input block by the second input block to obtain a result block; and
applying the first block scale factor to rows of the result block and applying the second block scale factor to columns of the result block to thereby obtain a scaled result block, wherein the scaled result block includes a plurality of scaled result block elements that are scaled to within a third scale range;
at an accumulator, accumulating a plurality of the scaled result blocks to obtain a scaled result matrix; and
transmitting the scaled result matrix to output memory of the hardware accelerator; and
outputting the scaled result matrix from the output memory.

11. The method of claim 10, wherein the processing circuitry includes a plurality of the tiles.

12. The method of claim 10, wherein:
the first block scale factor and the second block scale factor are block-level scale factors; and
a plurality of different block-level scale factors are applied at the one or more tiles.

13. The method of claim 10, wherein the first block scale factor and the second block scale factor are tensor-level scale factors that are associated with each of the first input blocks included in the first input matrix and with each of the second input blocks included in the second input matrix, respectively.

14. The method of claim 10, wherein the first block scale factor and the second block scale factor are each:
an eight-bit exponent, zero-bit mantissa (E8M0) number;
a two-bit exponent, two-bit mantissa (E2M2) number;
a five-bit exponent, three-bit mantissa (E5M3) number;
a three-bit exponent, five-bit mantissa (E3M5) number;
a two-bit exponent, zero-bit mantissa (E2M0) number; or
a three-bit exponent, zero-bit mantissa (E3M0) number.

15. The method of claim 10, wherein:
the tensor processor includes a respective dot product array of a plurality of dot product units; and
at each of the dot product units, the method further comprises:
computing a dot product of a respective row of the first input block and a respective column of the second input block;
applying the first block scale factor and the second block scale factor to the dot product to obtain a scaled dot product; and
outputting the scaled dot product.

16. The method of claim 15, wherein applying the first block scale factor and the second block scale factor to each of the dot products includes:
adding respective exponents of the first block scale factor, the second block scale factor, and the dot product to obtain a scaled dot product exponent of the scaled dot product; and
multiplying respective mantissas of the first block scale factor, the second block scale factor, and the dot product to obtain a scaled dot product mantissa of the scaled dot product.

17. The method of claim 15, wherein:
the first block scale factor, the second block scale factor, and the dot product include respective signs; and
applying the first block scale factor and the second block scale factor to each of the dot products includes computing an exclusive or (XOR) of the respective signs of the first block scale factor, the second block scale factor, and the dot product to obtain a scaled dot product sign of the scaled dot product.

18. The method of claim 10, further comprising, at the tensor processor:
receiving the first input block and the first block scale factor from a first input buffer included in the tile; and
receiving the second input block and the second block scale factor from a second input buffer included in the tile.

19. A tile included in processing circuitry of a hardware accelerator, the tile comprising:
a first input register configured to receive a first input block of a first input matrix;
a second input register configured to receive a second input block of a second input matrix;
a first scale factor buffer configured to receive a first block scale factor that is associated with rows of the first input block and specifies a first predefined scale range;
a second scale factor buffer configured to receive a second block scale factor that is associated with columns of the second input block and specifies a second predefined scale range;
a dot product array of a plurality of dot product units, wherein each of the dot product units is configured to:
compute a dot product of a respective row of the first input block and a respective column of the second input block;
apply the first block scale factor and the second block scale factor to the dot product to obtain a scaled dot product that is scaled to within a third scale range; and
output the scaled dot product;
an accumulator configured to accumulate the scaled dot products computed at the dot product units to compute a scaled result block; and
a result buffer configured to receive and output the scaled result block.

20. The tile of claim 19, wherein the dot product array is configured to apply the first block scale factor and the second block scale factor to each of the dot products at least in part by:
adding respective exponents of the first block scale factor, the second block scale factor, and the dot product to obtain a scaled dot product exponent of the scaled dot product; and
multiplying respective mantissas of the first block scale factor, the second block scale factor, and the dot product to obtain a scaled dot product mantissa of the scaled dot product.
